(19) United States
(12) Patent Application Publication
(10) Pub. No.: US 2008/0126063 A1
(43) Pub. Date: May 29, 2008

(54) Simulation System with Guided Backtracking

(76) Inventors: Ilan Beer, Haifa (IL); Eyal Bin, Haifa (IL); Daniel Geist, Haifa (IL); Ziv Nevo, Yokneam Ilit (IL); Gil Eliezer Shurek, Haifa (IL); Avi Ziv, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/534,238

(22) Filed: Sep. 22, 2006

(51) Int. Cl. G06F 17/50

(52) U.S. Cl. 703/14

(57) ABSTRACT

A method for design verification includes running a simulation of a design in a simulation environment, which comprises a stimuli generator for providing inputs to the design during the simulation. Respective measures of quality are computed for at least some of the simulation states in a sequence of states generated by the environment. State data are saved with respect to at least one of the simulation states. The state data include indications both of the respective simulated state and of the respective environment state. Responsively to the respective measures of quality, the saved state data are recalled so as to restart the simulation from the at least one of the simulation states by returning the design to the respective simulated state and returning the simulation environment to the respective environment state.

### FIELD OF THE INVENTION

The present invention relates generally to design verification, and specifically to methods and systems for simulation-based testing of complex designs.

### BACKGROUND OF THE INVENTION

Functional verification is widely recognized as the key bottleneck in the process of electronic integrated circuit design. Available verification tools have not kept pace with the rapid increase in design complexity, tighter time-to-market requirements, and higher quality expectations. In a typical microprocessor design project, more than half of the overall resources spent are devoted to verification, particularly unit-level verification, where bugs are most likely to be discovered. (A “bug” is defined herein as a violation of a specified property that the design is supposed to obey.)

The mainstream methodology for unit-level functional verification involves simulation of the hardware design in a “testbench” simulation environment. This environment is made up of software modules that may include transaction drivers and stimuli generators, signal and transaction monitors, checkers (simulation-run validators), coverage goals (or coverage models), and coverage-measurement and analysis mechanisms. These modules may be configured to permit engineers to use their own insight in biasing the simulation toward “interesting” regions of the design state space. For example, U.S. Pat. No. 6,925,405 describes adaptive test generators and event detection for use in a simulation environment. As another example, coverage measurement and its use in guiding test generation are described in U.S. Patent Application Publication 2006/0048026. Simulation checkers based on temporal logic formulas are described in U.S. Patent Application Publication 2003/0018461. The disclosures of the above-mentioned patent and patent application publications are incorporated herein by reference.

Even with these advanced tools, it is still very difficult to ensure that a device simulation will reach all possible bugs. Formal verification techniques, in contrast to simulation, are capable of searching a state space exhaustively, and thus discovering all bugs that may occur in the space. Such formal techniques are limited, however, by the computational problem of “state space explosion.” A number of attempts have therefore been made to combine simulation with formal techniques in order to guide the simulation toward bug states.

An approach of this sort is described, for example, by Shyam et al., in “GUIDO: Hybrid Verification by Distance-Guided Simulation,” International Workshop on Logic and Synthesis (Lake Arrowhead, Calif., 2005), which is incorporated herein by reference. Guido provides a “trace sequence controller” that forces the simulator to get incrementally closer to a specific verification goal. The trace sequence controller relies on a hill-climbing algorithm and a cost function associated with each state of the design. The controller complements its baseline hill-climbing technique with mechanisms that exploit the random nature of the simulation when beneficial and bypass it by inserting single-step deterministic improvements when the search is not fruitful. The cost function used in Guido indicates the distance of each state from the goal based on a backward reachability analysis (derived from formal verification techniques) over an abstraction of the design.

### SUMMARY OF THE INVENTION

There is therefore provided, in accordance with an embodiment of the present invention, a method for design verification. The method includes running a simulation of a design in a simulation environment, which includes a stimuli generator for providing inputs to the design during the simulation, thereby generating a sequence of simulation states. Each simulation state includes a respective simulated state of the design and a respective environment state of the simulation environment, which includes a generator state of the stimuli generator.

Respective measures of quality of at least some of the simulation states in the sequence are computed. State data with respect to at least one of the simulation states are saved. The state data include indications both of the respective simulated state and of the respective environment state. Responsively to the respective measures of quality, the saved state data are recalled so as to restart the simulation from the at least one of the simulation states by returning the design to the respective simulated state and returning the simulation environment to the respective environment state.

Other embodiments of the present invention provide apparatus and computer software products for design verification.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for design verification, in accordance with an embodiment of the present invention;

FIG. 2 is a block diagram that schematically shows functional elements of a simulation environment, in accordance with an embodiment of the present invention;

FIG. 3 is a graph that schematically illustrates a simulated progression through states of a design under test, in accordance with an embodiment of the present invention; and

FIG. 4 is a flow chart that schematically illustrates a method for design verification, in accordance with an embodiment of the present invention.

### DETAILED DESCRIPTION OF EMBODIMENTS

Embodiments of the present invention that are described hereinbelow provide methods and systems for guiding a design simulation efficiently toward a target state, such as a state in which a bug occurs. These methods may be used in conjunction with new or existing simulation environments, in which a stimuli generator, which is typically software-based, is used to provide inputs to a simulated design under test. The simulation environment may also comprise other components, such as event monitors and checkers. These embodiments can take advantage of both the knowledge of the verification engineer, which is typically coded into the stimuli generator and is used to bias the stimulation toward areas of interest in the simulation state space, and knowledge that is automatically extracted from the simulation itself, as described hereinbelow.

As the simulation runs, it generates a sequence of simulation states, each corresponding to a certain simulated state of the design and an accompanying environment state of the simulation environment. A simulation controller (which may itself be a software component of the simulation environment) computes quality measures of the simulated states, which are typically indicative of the likelihood that a given simulated state will lead to a target state as the simulation progresses. One or more target states may be designated for this purpose, and the quality measures may relate to any or all of these target states. The simulation controller saves state data with respect to some or all of the simulation states, wherein the state data include indications of the both the simulated state of the design and of the environment state of elements of the simulation environment, such as the stimuli generator.

The simulation controller monitors the quality of the successive simulation states as the simulation progresses. If the controller determines that the current simulation path is unlikely to lead to one of the target states, the controller interrupts the simulation in order to restart the simulation from another state—typically a high-quality state that was generated and saved previously. The saved state data from this state are recalled and loaded into the simulator so as to return both the design under test and the elements of the simulation environment to their previous states. As a result, not only is the simulation able to backtrack to a more promising state that was visited earlier, but the simulation environment is able to use knowledge acquired in the previous pass through that state so as to choose another, more promising path forward through the simulated states of the design.

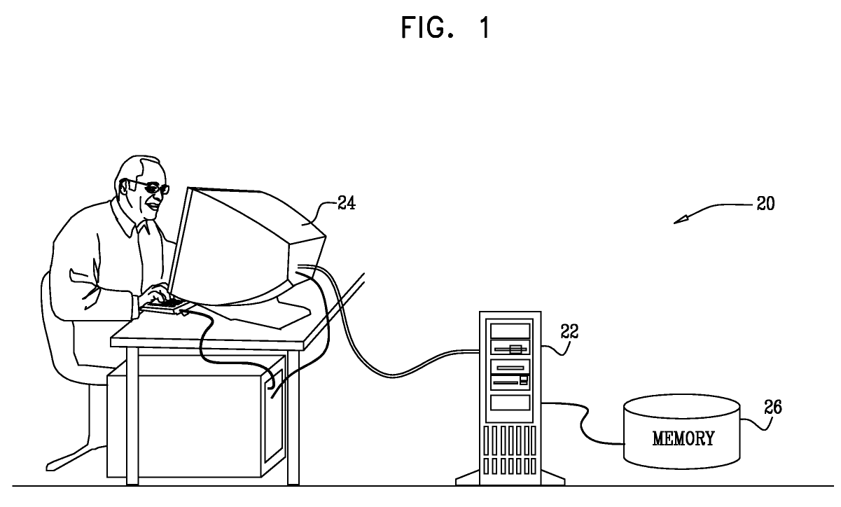

FIG. 1 is a schematic, pictorial illustration of a system 20 for design verification, in accordance with an embodiment of the present invention. A simulation processor 22 runs a simulation to verify a design under test, such as a unit-level design. Typically, the simulation processor comprises a general-purpose computer, which is programmed in software to carry out the functions described herein. This software may be downloaded to processor 22 in electronic form, over a network, for example, or it may alternatively be provided on tangible media, such as optical, magnetic or electronic storage media. Alternatively or additionally, at least some of the functions of processor 22 may be implemented in dedicated or programmable electronic hardware. A memory 26 coupled to processor 22 stores program instructions and data used by the processor in running the simulation.

Processor 22 receives simulation instructions from a verification engineer via an input interface 24. These instructions include, inter alia, definitions of the design under test (typically in a hardware description language—HDL) and specifications of the properties of the design that are to be verified. The verification engineer may also specify test directives, indicating the types of stimuli to be generated, the types of bugs to be sought, and coverage goals to be achieved in a particular simulation run. These user inputs may be provided in either declarative form or in a non-declarative program language, in accordance with suitable conventions that are known in the art.

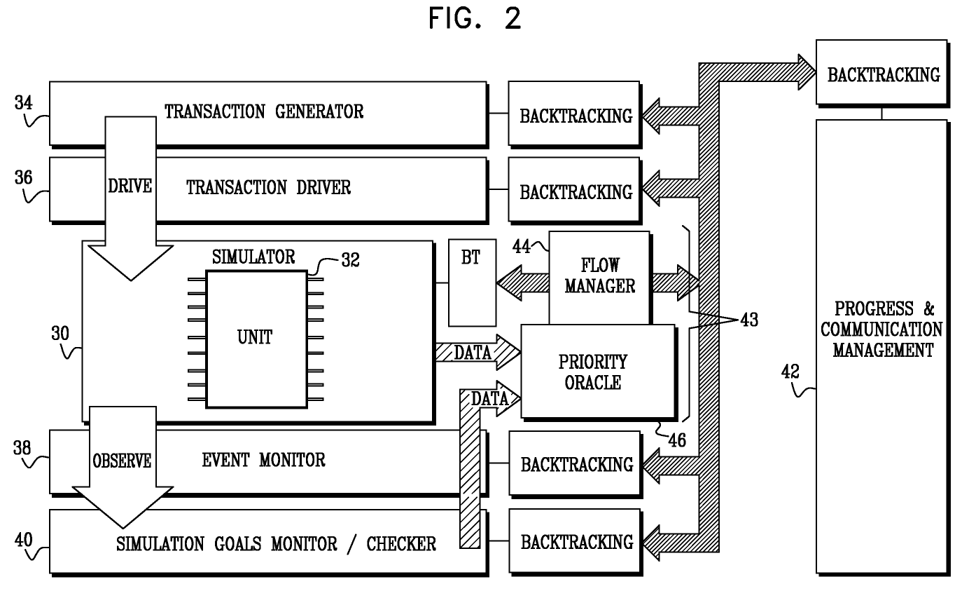

FIG. 2 is a block diagram that schematically shows elements of a simulation environment that may run on processor 22, in accordance with an embodiment of the present invention. A simulator 30 steps through the states of the design under test, shown here as a unit 32. As noted above, the design is typically input to the simulator in a synthesizable form (i.e., written in a language, such as HDL, that defines the design in terms of a netlist and finite state machine, so that it can be readily translated into a corresponding electronic circuit). A transaction generator 34, which may also be referred to as a stimuli generator, generates stimuli for use in the simulation. These stimuli generally have the form of test directives, which comprise lists of instructions and data inputs to be applied to unit 32. Typically, the stimuli are generated at random, subject to constraints and biases that may be specified by the verification engineer in order to drive the simulation toward areas of interest in the state space of unit 32, such as areas that test certain properties of the device and may reveal undiscovered bugs. A transaction driver 36 converts these stimuli into the actual test programs that are used to drive simulator 30 by abstracting the interface of unit 32 and managing the interface protocols.

An event monitor 38 observes the progress of the simulation by abstracting the outputs and internal state of unit 32. Monitor 38 generates an event indication when a specified condition is satisfied with respect to the simulated state of unit 32. Typically, the event monitor is configured to detect many different types of events simultaneously. A goal monitor 40 receives and analyzes the event indications in order to compare the simulation results to the goals of the simulation, in terms of coverage and bug detection. Monitor 40 may comprise checkers, which detect specific combinations and sequences of events that are indicative of bugs in the unit design. A simulation manager 42 tracks and controls the progress of the simulation, as well as informing the verification engineer of the simulation results.

The elements of the simulation environment described above, such as transaction generator 34, transaction driver 36, event monitor 38, and goal monitor 40, are present in simulation systems known in the art. Exemplary implementations of these elements are described in the publications cited above in the Background of the Invention. Whereas unit 32 is typically defined by HDL code, as noted above, the elements of the simulation environment are more conveniently written in non-synthesizable software languages, such as C++, E or Vera, or possibly in a suitable declarative language. A typical simulation environment of this sort is provided, for example, by the Specman Elite® verification environment offered by Cadence Design Systems (San Jose, Calif.).

In order to enhance the ability of the simulation environment to reach particular target states of unit 32—typically states in which bugs occur—a simulation controller 43 receives, processes and stores data from elements of the environment. When required, controller 43 instructs the components of the environment to backtrack to states of the simulation that were traversed earlier. The input/output links between controller 43 and the other elements of the simulation environment may be effected by suitable instrumentation of the software code of these elements, causing these elements to output the appropriate data and receive certain instructions from the controller. The simulation controller itself may comprise software components of the simulation environment, running on processor 22. Alternatively, the simulation controller may be implemented on a separate processor (not shown).

Simulation controller 43 comprises a priority oracle 46, which evaluates the states of the simulation (including both the simulated state of unit 32 and the environment state of the elements of the simulation environment) and computes a measure of state quality. This measure is typically indicative of the likelihood that the given simulation state will lead, as the simulation progresses, to a particular target state. The measure may be based on one or more heuristics, or a combination of such heuristics, as is described further hereinbelow.

The simulation controller also comprises a flow manager 44, which receives the state quality measures from priority oracle 46 and saves simulation states of high quality in a priority queue. Typically, the state of highest quality is placed at the head of the queue. When the flow manager determines that the current simulation path is “cold,” i.e., that it is unlikely to lead to a target state, it typically interrupts the simulation and instructs the elements of the simulation environment to backtrack to the state at the head of the priority queue and continue the simulation from there. Alternatively, the flow manager may permit the cold simulation path to reach an end point without interruption, and then restart the simulation from a high-quality state. As noted earlier, this backtracking involves restoring not only the values of the variables in unit 32 (the simulated state), but also restoring values of variables that define the state of software elements, such as transaction generator 34 and monitors 38 and 40, that make up the simulation environment (the environment state). Not all variables are necessarily saved and restored: for example, backtracking typically does not affect random decision objects in the transaction generator and management objects in simulation manager 42.

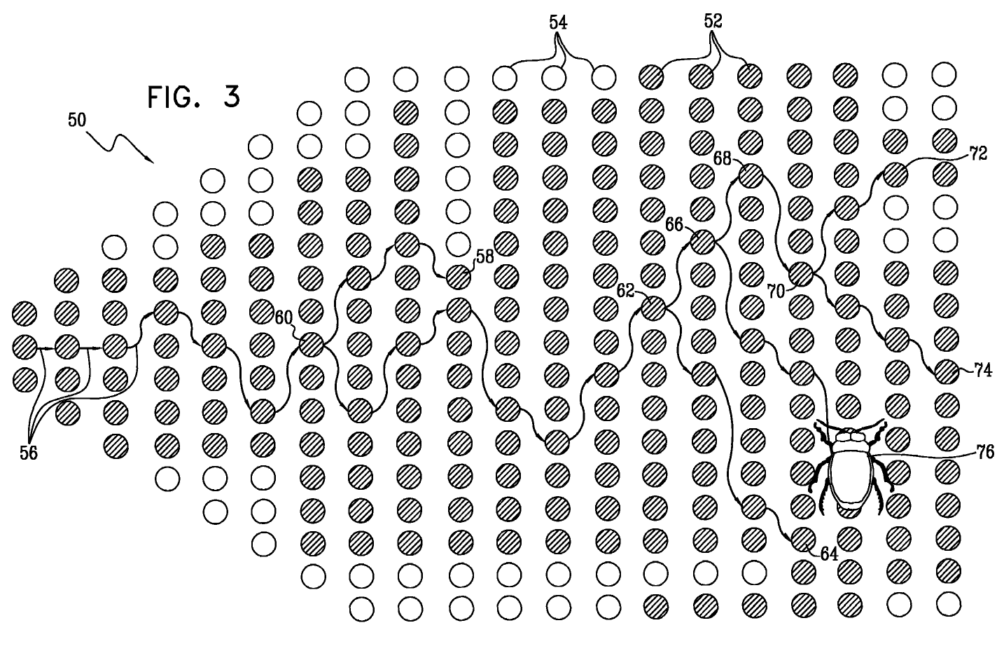

FIG. 3 is a graph 50 that schematically illustrates a state space 50 of a design under test, illustrating principles of the present invention. Typically, the state space comprises both reachable states 52 and unreachable states 54 (i.e., states that the design cannot possible assume). Arrows 56 represent successive transitions from state to state in the simulation. A sequence of these transitions corresponds to a simulation path. As explained above, controller 43 records the quality measure of the states as the simulation progresses.

In the example shown in the figure, controller 43 determines at state 58 that the current path of the simulation has grown “cold,” i.e., the trend of the quality measures of the states along this path indicates that the path is unlikely to lead to a target state. This determination may be based not only on the quality measure of state 58, but also on the quality measures of the preceding states along the path. Various heuristics may be applied in deciding that a given path is cold, such as finding that the quality measures of a certain number of states are below some threshold, and/or that the slope of the successive quality measures is negative. It may be advantageous to permit one or more successive states along the path to have a lower quality measure than a preceding state, rather than to require the quality measure to increase monotonically from state to state. This sort of flexibility will enable the simulation to traverse regions of complex state space topology autonomously, without having to resort to user-intervention or exhaustive formal searching of the state space.

Upon determining that the current path is cold, controller 43 restores the simulation to an earlier state 60, which was previously found to be “warm” and was therefore saved at the head of the priority queue. Because the controller restores not only the state of unit 32, but also the states of elements of the simulation environment, transaction generator 34 is able to drive simulator 30 onto a new path, using the implicit knowledge gained from the preceding pass through state 60. Alternatively or additionally, as noted above, controller 43 may simply allow the current path to reach its end point without interruption, and may then restart the simulation from a warm state found previously.

The simulation proceeds through a state 62 to a state 64, and then backtracks again to state 62 and continues through states 66, 68 and 70 to a state 72. Upon finding this state to be cold, controller 43 backtracks first to state 70 and reaches another cold state 74. Therefore, the controller goes back to the next state in the priority queue, state 66, and is finally able to reach a target state 76 where a bug is discovered.

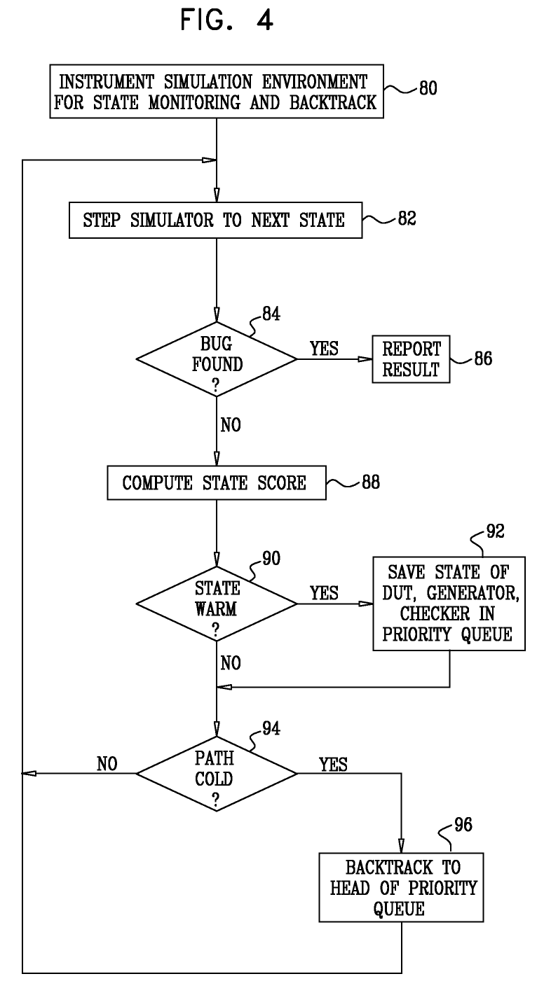

FIG. 4 is a flow chart that schematically illustrates a method for design verification in a simulation environment, in accordance with an embodiment of the present invention. The method is described, for the sake of convenience and clarity, with reference to the simulation environment of FIG. 2, but the principles of this method are similarly applicable in other simulation environments, as are known in the art. In preparation for simulation, the simulation environment is instrumented for monitoring and backtracking, at an instrumentation step 80. As explained above, this instrumentation enables controller 43 to receive simulation data and to backtrack by restoring the states of unit 32 in simulator 30 and of other elements of the simulation environment to their earlier states. The instrumentation may take the form of added software code for providing data outputs to and receiving control inputs from controller 43. Although step 80 is shown as part of the verification method in FIG. 4, in practice it is generally sufficient to perform the instrumentation only once, although monitoring and decision parameters used by controller 43 may be varied from one simulation run to the next. An exemplary method of instrumentation is described in the Appendix below.

Upon initiation of the simulation, transaction generator 34 and transaction driver 36 generate the initial set of inputs to simulator 30. The simulator receives the inputs and advances the simulated state of unit 32 accordingly, at a simulation step 82. After each simulation step (or possibly after a group of steps), event monitor 38 receives the relevant state and output values from simulator 30 and generates event indications, which are processed by goal monitor 40. The goal monitor checks the events against predetermined criteria, using checkers, coverage criteria and other tools, as are known in the art, at an event evaluation step 84. This evaluation enables the goal monitor to determine whether unit 32 has reached a target state, typically a state in which a bug occurs. If a bug is detected, the goal monitor reports the bug to simulation manager 42, at a reporting step 86. The simulation manager then takes the appropriate action, such as recording the bug and/or notifying the verification engineer.

If the simulation does not reach a target state at step 84, priority oracle 46 gathers data regarding the current state, at a scoring step 88. These data are used in computing the quality measure for the current state, which typically has the form of a heuristic score. Various different types of heuristics may be used in the computation, for example:
Bug-directed heuristics—These heuristics estimate the distance from a given state (measured in simulation cycles) to a possible bug. They may rely on an analysis of a state machine used by a specific checker in monitor 40, or on approximated backward steps of the device under test from a set of failure states. Examples of these sorts of heuristics are described hereinbelow. The verification engineer may also use his or her own intuition in order to score the states of a checker with respect to their distance from a bug. This scoring is typically coded into the checker in advance, before the simulation begins.
Bug-pattern based heuristics—These heuristics aim to direct the simulation toward faulty behaviors by comparing the simulated design state to a set of known bug patterns. Examples may include asserted FIFO-full signals and nearly overflowed counters.
Distribution-based heuristics—These heuristics aim to improve search distribution, by preferring states exhibiting rarely-seen characteristics, such as unusual signal values, signal combinations or checker states. By spreading the search distribution, these heuristics increase the likelihood that the subsequent simulation will reach a bug via paths that would otherwise be only rarely traversed.

As described in the above-mentioned U.S. Patent Application Publication 2003/0018461, for example, checkers operated by goal monitor 40 may themselves comprise state machines (referred to as “satellites”), which have terminal states (also referred to as failure states) that correspond to bugs in unit 32. In other words, each relevant event indication generated by event monitor 38 advances the state of the checker, and occurrence of a certain sequence of events leads to the terminal state of the checker. The “satellite distance” of a simulation state corresponds to the minimum number of steps that the checker state machine will require to reach a terminal state starting from the current simulation state. To compute the satellite distance, oracle 46 may perform a backward breadth-first search from the terminal state until it reaches the current state of the checker. The oracle then assigns higher scores to states with low satellite distance. The oracle may give added weight to checker states that it has encountered less frequently during the simulation, in order to increase the chances of traversing all possible paths through the checker state space.

As noted above, other bug-directed heuristics may be derived from the distance of the simulated state of the design under test (unit 32 in the present example) from known failure states of the design. For this purpose, the state space of the design may be framed in a formal representation, using a binary decision diagram (BDD), for example. Oracle 46 then performs successive pre-image computations to step backward through the state space from the failure state. To reduce computational complexity, an approximate, abstracted representation of the state space may be used, as described, for example, in U.S. Pat. No. 6,957,404, whose disclosure is incorporated herein by reference. The simulated design distance of each simulated state is then given by the minimum number of backward steps (i.e., pre-image operations) that must be taken to reach the simulated state from the failure state. Again, the lower the distance, the higher will be the score.

Distribution-based heuristics may be based on coverage statistics, which may indicate, for example, how densely the region of the state space in which the current simulation state is located has been explored by previous simulation cycles. In other words, a state in a “dark corner” of the state space, which has been touched only sparsely (or not at all) by the simulation, receives a high score, whereas states in densely-explored regions receive low scores. The score may be evaluated, for example, by computing the average value of each flip-flop (FF), between 0 and 1, in the simulation, and scoring each state in proportion to the distance of the FFs in that state from their average values. Additionally or alternatively, correlations may be computed between different pairs of FFs, and the score may be proportional to the differences between the correlations in the current state and the average correlation values. Further additionally or alternatively, oracle 46 may monitor the values of certain interface signals, and may score the simulation states so as to favor combinations of the interface signals that have not yet been covered.

Typically, at step 88, oracle 46 computes multiple different heuristics. The total score (quality measure) for each state may be a weighted sum of the individual heuristics. Alternatively, the quality measure may have the form of a vector or any other suitable computational form that is known in the art.

Flow manager 44 evaluates the current state score, at a state evaluation step 90. A high score indicates that the state is “warm,” i.e., that it has a relatively high likelihood of leading to a bug. If the state is sufficiently warm, manager 44 saves the state in the priority queue, at a state saving step 92. The saved information, as explained above, includes not only the variables of unit 32 (the simulated state of the device under test), but also certain variables associated with elements of the simulation environment (the environment state), such as transaction generator 34 and checkers used in monitor 40, for example.

Flow manager 44 also checks the score of the present state, and typically of a number of preceding states along the current simulation path, in order to determine whether the current path is cold, at a path evaluation step 94. (Generally speaking, if the current state was found to be warm at step 90, the path will not be considered cold at step 94, but this possibility is included in the flow chart for the sake of completeness.) As noted above, the path quality may be determined by a combination of factors, including the score of the present state and the trend of scores over the preceding states. As long as the path is not cold, manager 44 instructs simulator 30 to continue stepping along the same path, at step 82.

Otherwise, upon determining that the current path is cold, manager 44 retrieves the saved state information regarding the state at the head of the priority queue, and instructs the simulation environment to backtrack to the saved state, at a backtracking step 96. At this step, the saved variable values are restored to all the applicable elements of the simulation environment, as illustrated in FIG. 2. Dynamic objects may also be restored, in addition to static variable values. Typically, manager 44 removes the backtracked state from the head of the priority queue, so that another state will be selected next time the manager decides that backtracking is called for. Alternatively, manager 44 may cause the simulation to backtrack to the same state two or more times, in order to try different paths originating from the state, before removing the state from the priority queue. The simulation then continues from step 82.

Although a certain architecture of the simulation environment is shown in FIG. 2 for the sake of clarity, and certain specific heuristics for computing state quality measures are described above by way of example, the principles of the present invention are similarly applicable in other simulation environments and using heuristics of other types. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to n reading the foregoing closed in the prior art.

Appendix—Instrumentation of Simulation Environment

At step 80, an instrumentation utility scans the simulation environment code. The utility adds the following methods to each class:
saveState—This method serially dumps all require data members into a Snapshot buffer. This process is referred to as “serialization.” It also saves existing objects in the system, allowing subsequent recreation of dynamic objects, and deletion of unnecessary ones.
loadState—This method restores values of all required data members from the serialized Snapshot buffer. This process is referred to as “de-serialization.”

### In C++, the above processes are accomplished simply by declaring and defining the appropriate additional methods for each class.

The required classes are registered for backtracking, so that the flow manager will call the saveState methods of these classes when it encounters a warm state and will call their loadstate methods when it decides to backtrack. In C++, the registration may be added to the constructor of each class. For example, assume a simple C++ class, defined as:

```
class PortTag
{
  public:
    PortTag( ) : _port(−1), _tag(−1{ })
    virtual ~PortTag{ }( )
  public:
    int  _port;
    int  _tag;
};
```

The following code is then added to all constructors:

REGISTER_BACKTRACKING (PortTag, loadstate, savestate}; The following functions are also added:

```
void PortTag::saveState(AsSnapshot & snapshot) const
{
  snapshot.save(_port);
  snapshot.save(_tag);
}
void PortTag::loadState(AsSnapshot &snapshot(
{
  snapshot.load(_port);
  snapshot.load(_tag);
}
```

1. A method for design verification, comprising:
running a simulation of a design in a simulation environment, which comprises a stimuli generator for providing inputs to the design during the simulation, thereby generating a sequence of simulation states, each comprising a respective simulated state of the design and a respective environment state of the simulation environment, which comprises a generator state of the stimuli generator;
computing respective measures of quality of at least some of the simulation states in the sequence;
saving state data with respect to at least one of the simulation states, the state data comprising indications both of the respective simulated state and of the respective environment state;
responsively to the respective measures of quality, recalling the saved state data so as to restart the simulation from the at least one of the simulation states by returning the design to the respective simulated state and returning the simulation environment to the respective environment state.

2. The method according to claim 1, wherein the simulation environment comprises a checker, for evaluating the simulated state of the design, and wherein saving the state data comprises saving a checker state of the checker.

3. The method according to claim 2, wherein the checker comprises a state machine having a terminal state corresponding to a target state of the design, and wherein computing the respective measures of quality comprises determining a number of steps of the state machine between a current state of the state machine and the terminal state.

4. The method according to claim 1, wherein computing the respective measures of quality comprises computing a distance in a state space of the simulation between each of the at least some of the simulation states and a target state of the simulation.

5. The method according to claim 4, wherein computing the distance comprises searching backward over successive simulation cycles from the target state, and determining the respective measures of quality responsively to a respective number of the simulation cycles that is required to reach each of the at least some of the simulation states from the target state.

6. The method according to claim 1, wherein computing the respective measures of quality comprises comparing the respective simulated state in each of the at least some of the simulation states to a known bug pattern.

7. The method according to claim 1, wherein computing the respective measures of quality comprises determining statistics of coverage by the simulation of a region of a state space in which each of the at least some of the simulation states occurs.

8. The method according to claim 1, wherein saving the state data comprises saving variables used by non-synthesizable elements of the simulation environment, and wherein returning the simulation environment to the respective environment state comprises restoring the saved variables to the non-synthesizable elements.

9. The method according to claim 1, wherein saving the state data comprises determining, based on the respective measures of quality, that there is a relatively high likelihood that the at least one of the simulation states will lead to a target state of the simulation, and selecting the at least one of the simulation states to be saved responsively to the likelihood.

10. The method according to claim 9, wherein saving the state data comprises placing a plurality of the simulation states, including the at least one of the simulation states, in a priority queue responsively to the respective measures of quality, and wherein recalling the saved state data comprises retrieving one of the simulation states from a head of the priority queue.

11. The method according to claim 9, wherein interrupting the simulation comprises determining, responsively to the respective measures of quality, that there is a relatively low likelihood that one or more of the simulation states most recently traversed by the simulation will lead to the target state.

12. The method according to claim 1, wherein recalling the saved data comprises interrupting the simulation responsively to determining, based on the respective measures of quality, that there is a relatively low likelihood that a present simulation path will lead to a target state of the simulation.

13. Apparatus for design verification, comprising:
a memory; and
a simulation processor, which is arranged to run a simulation of a design in a simulation environment, which comprises a stimuli generator for providing inputs to the design during the simulation, thereby generating a sequence of simulation states, each comprising a respective simulated state of the design and a respective environment state of the simulation environment, which comprises a generator state of the stimuli generator, and which is arranged to compute respective measures of quality of at least some of the simulation states in the sequence and to save in the memory state data with respect to at least one of the simulation states, the state data comprising indications both of the respective simulated state and of the respective environment state,
wherein the simulation processor is arranged, responsively to the respective measures of quality, to recall the saved state data so as to restart the simulation from the at least one of the simulation states by returning the design to the respective simulated state and returning the simulation environment to the respective environment state.

14. The apparatus according to claim 13, wherein the simulation environment comprises a checker, for evaluating the simulated state of the design, and wherein the state data saved by the simulation processor comprises an indication of a checker state of the checker.

15. The apparatus according to claim 13, wherein the respective measures of quality are indicative of a distance in a state space of the simulation between each of the at least some of the simulation states and a target state of the simulation.

16. The apparatus according to claim 13, wherein the respective measures of quality are determined by a density of coverage by the simulation of a region of a state space in which each of the at least some of the simulation states occurs.

17. The apparatus according to claim 13, wherein the at least one of the simulation states to be saved is selected responsively to determining, based on the respective measures of quality, that there is a relatively high likelihood that the at least one of the simulation states will lead to a target state of the simulation.

18. A computer software product, comprising a computer-readable medium in which program instructions are stored, which instructions, when read by a computer, cause the computer to run a simulation of a design in a simulation environment, which comprises a stimuli generator for providing inputs to the design during the simulation, thereby generating a sequence of simulation states, each comprising a respective simulated state of the design and a respective environment state of the simulation environment, which comprises a generator state of the stimuli generator, and cause the computer to compute respective measures of quality of at least some of the simulation states in the sequence and to save state data with respect to at least one of the simulation states, the state data comprising indications both of the respective simulated state and of the respective environment state,
wherein the instructions cause the computer, responsively to the respective measures of quality, to interrupt the simulation and recall the saved state data so as to restart the simulation from the at least one of the simulation states by returning the design to the respective simulated state and returning the simulation environment to the respective environment state.

19. The product according to claim 18, wherein the respective measures of quality are indicative of a distance in a state space of the simulation between each of the at least some of the simulation states and a target state of the simulation.

20. The product according to claim 18, wherein the respective measures of quality are determined by a density of coverage by the simulation of a region of a state space in which each of the at least some of the simulation states occurs.
